(19) United States
(12) Patent Application Publication
(10) Pub. No.: US 2018/0365601 A1
(43) Pub. Date: Dec. 20, 2018

(54) SERVICE RESERVATION METHOD AND APPARATUS

(71) Applicant: Alibaba Group Holding Limited, Grand Cayman (KY)

(72) Inventors: Lisha Shi, Hangzhou (CN); Xijun Wang, Hangzhou (CN)

(73) Assignee: Alibaba Group Holding Limited

(21) Appl. No.: 16/119,958

(22) Filed: Aug. 31, 2018

Related U.S. Application Data
(63) Continuation of application No. PCT/CN2017/074316, filed on Feb. 21, 2017.

(30) Foreign Application Priority Data
Mar. 3, 2016 (CN) 201610122321.8

(51) Int. Cl. G06Q 10/02; H04L 12/58

(52) U.S. Cl. CPC G06Q 10/02; H04L 51/046

(57) ABSTRACT

A method including receiving a reservation request for a preset service initiated by a preset instant messaging application; determining a service mode designated by the reservation request; and responding to the reservation request according to the service mode to enable an initiator of the reservation request to obtain the preset service. The technical solution according to the present disclosure helps a user achieve a convenient and fast service reservation operation.

### CROSS REFERENCE TO RELATED PATENT APPLICATIONS

This application claims priority to and is a continuation of PCT Patent Application No. PCT/CN2017/074316, filed on 21 Feb. 2017, which claims priority to Chinese Patent Application No. 201610122321.8 filed on 3 Mar. 2016 and entitled “SERVICE RESERVATION METHOD AND APPARATUS”, which are incorporated herein by reference in their entirety.

### TECHNICAL FIELD

The present disclosure relates to the field of communication technologies, and, more particular, to service reservation methods and apparatuses.

### BACKGROUND

When a user needs to make a reservation for a service, the user often needs to communicate and make confirmation by phone, and even has to visit a service provider in person. The process is complicated, and the user may need to have multiple visits, which is very inconvenient.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

In view of the above, the present disclosure provides a service reservation method and apparatus, which helps a user achieve a convenient and fast service reservation operation.

In order to achieve the foregoing objective, the present disclosure provides technical solutions as follows:

According to a first aspect of the present disclosure, a service reservation method is provided, including:

receiving a reservation request for a preset service initiated by a preset instant messaging application;

determining a service mode designated by the reservation request; and

responding to the reservation request according to the service mode to enable an initiator of the reservation request to obtain the preset service.

According to a second aspect of the present disclosure, a service reservation apparatus is provided, including:

a receiving unit configured to receive a reservation request for a preset service initiated by a preset instant messaging application;

a determining unit configured to determine a service mode designated by the reservation request; and

a response unit configured to respond to the reservation request according to the service mode to enable an initiator of the reservation request to obtain the preset service.

As shown from the foregoing technical solutions, the present disclosure provides a user with a fast reservation for a preset service by receiving a reservation request from the user, and the user does not need to communicate by phone or visit the service provider in person. The process is fast and convenient, and helps improve application experience of the user.

### BRIEF DESCRIPTION OF THE DRAWINGS

The accompanying drawings described here are used to provide a further understanding of the present disclosure, and constitute a part of the present disclosure. The example embodiments of the present disclosure and their descriptions are used to explain the present disclosure, and do not pose any improper limitation to the present disclosure.

FIG. 1 is a flowchart of a service reservation method according to an example embodiment of the present disclosure;

FIG. 2 is a flowchart of a teaching reservation service according to an example embodiment of the present disclosure;

FIG. 3A to FIG. 3F are schematic diagrams of an interface of a teaching reservation service according to an example embodiment of the present disclosure;

FIG. 4 is a flowchart of another teaching reservation service according to an example embodiment of the present disclosure;

FIG. 5A to FIG. 5H are schematic diagrams of an interface of another teaching reservation service according to an example embodiment of the present disclosure;

FIG. 6 is a flowchart of another teaching reservation service according to an example embodiment of the present disclosure;

FIG. 7A to FIG. 7C are schematic diagrams of an interface of another teaching reservation service according to an example embodiment of the present disclosure;

FIG. 8 is a schematic structural diagram of an electronic device according to an example embodiment of the present disclosure; and

FIG. 9 is a block diagram of a service reservation apparatus according to an example embodiment of the present disclosure.

### DETAILED DESCRIPTION

To enable those skilled in the art to better understand the solutions of the present disclosure, the technical solutions in the example embodiments of the present disclosure will be described below with reference to the accompanying drawings in the example embodiments of the present disclosure. It is obvious that the example embodiments only represent some of rather than all of the example embodiments of the present disclosure. All other example embodiments derived by those of ordinary skill in the art based on the example embodiments of the present disclosure without creative efforts should fall within the protection scope of the present disclosure.

The following embodiments are provided in order to further describe the present disclosure.

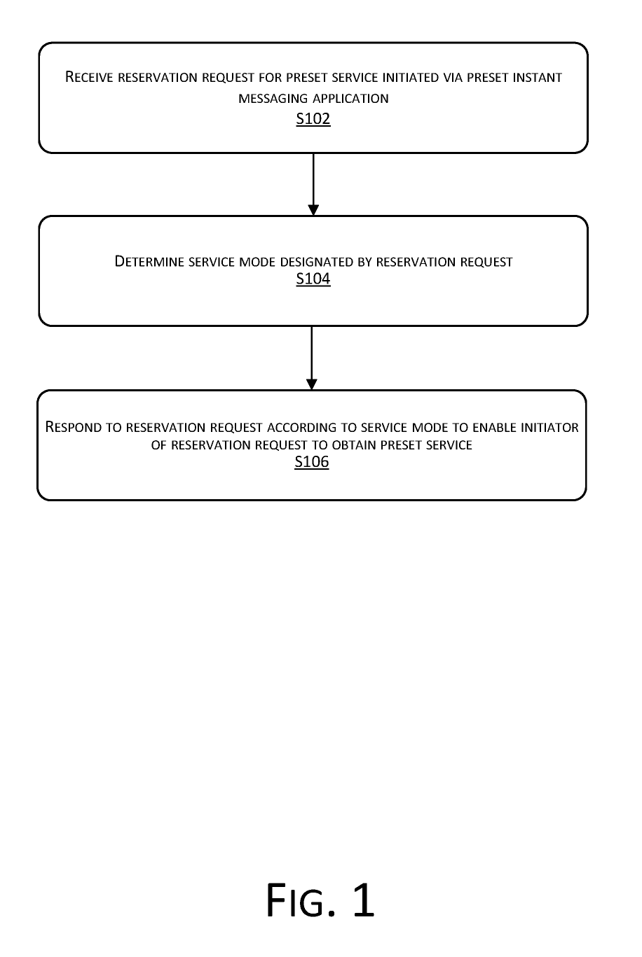

FIG. 1 is a flowchart of a service reservation method according to an example embodiment of the present disclosure. As shown in FIG. 1, the method is applied to a server, and may include the following steps:

Step 102: A reservation request for a preset service initiated via a preset instant messaging application is received.

In this embodiment, the preset service may be of any type in the related art, for example, a catering service, a teaching service, and so on, which is not limited in the present disclosure. For instance, when the preset service is a teaching service, the preset service may specifically be a teaching service for a preset application function in the preset instant messaging application. For example, after a user installs the preset instant messaging application on a terminal such as a mobile phone and a tablet device, a server provides corresponding server terminal and cloud terminal functions, so as to help the preset instant messaging application implement the corresponding function. Then, in the technical solution of the present disclosure, when the user is unfamiliar with a preset application function in the preset application and wants to participate in a teaching service organized by a developer, a senior user, or the like, the foregoing server further provides the user with a function for reserving the teaching service to help the user obtain the corresponding teaching service, thus reducing the self-study cost of the user.

At the same time, as the instant messaging application is increasingly widespread and used in people's daily life with increasing frequency, combining a reservation function for a preset service with the instant messaging application enables the user to initiate a corresponding service reservation more conveniently and quickly, which is conducive to simplifying user operations and improving user experience. The preset instant messaging application may be an instant messaging application of any type, for example, an Enterprise Instant Messaging (EIM) application such as “DING Talk”.

In this embodiment, the initiator of the reservation request may be a single user. For example, the user initiates a request in his/her own name to obtain a preset service for an individual, or the user initiates a request in the name of a team to which the user belongs to obtain a preset service for a team. Alternatively, the initiator may also be a group, such as a working group and an enterprise, to obtain a preset service for a group.

Step 104: A service mode designated by the reservation request is determined.

Step 106: A response is made to the reservation request according to the service mode to enable an initiator of the reservation request to obtain the preset service.

In this embodiment, there are many modes for the preset service. The server needs to adopt, with respect to a service mode selected by a user, the corresponding mode to respond to the reservation request initiated by the user, thus ensuring that the user completes the reservation for the corresponding preset service. For example, when the preset service is a catering service, the corresponding service mode may correspond to a catering type required by the user, such as Chinese food or western food. Alternatively, the corresponding service mode may correspond to the meal time required by the user, such as breakfast, lunch or dinner, so that a corresponding responding operation is performed for the service mode required by the user, such as reserving a table at a corresponding restaurant.

It may be known from the foregoing embodiment that the present disclosure may provide a user with a rapid reservation for a preset service by receiving a reservation request of the user, the user does not need to communicate by phone or go to the site by himself/herself, and the process is fast and convenient, which helps improve the user's application experience.

The technical solution of the present disclosure is described in detail below in combination with the initiator of the reservation request, the server, and the provider of the preset service. For ease of understanding, for example, an EIM application is “DING Talk”, and the process of making a reservation and experiencing a teaching service through “DING Talk” is described in the following embodiment in a scenario where the user needs to understand and learn about preset application functions of “DING Talk”.

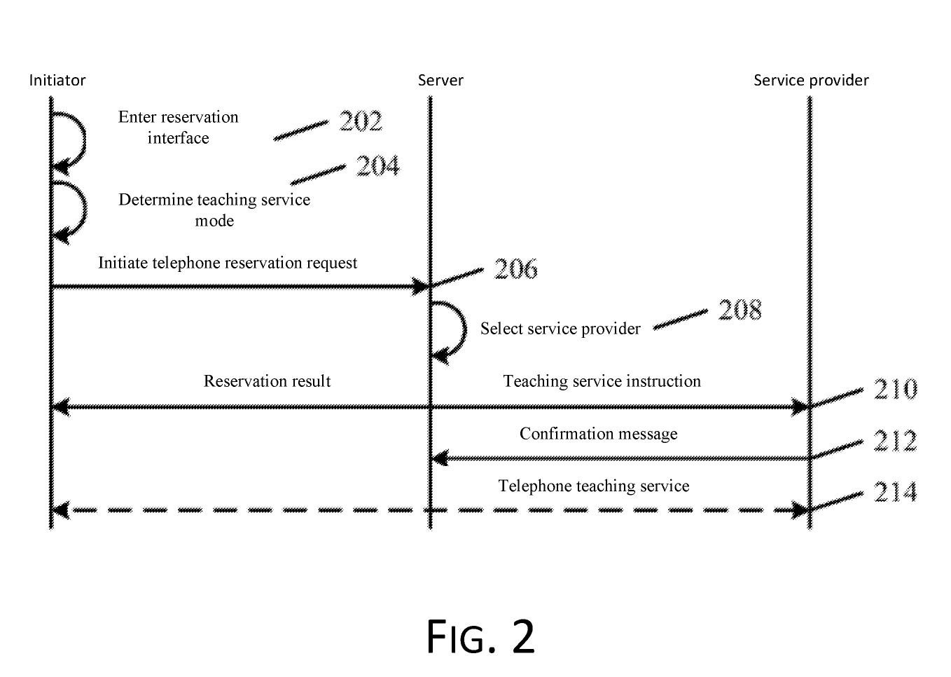

FIG. 2 is a flowchart of a teaching reservation service according to an example embodiment of the present disclosure. As shown in FIG. 2, the process may include the following steps:

Step 202: An initiator enters a reservation interface.

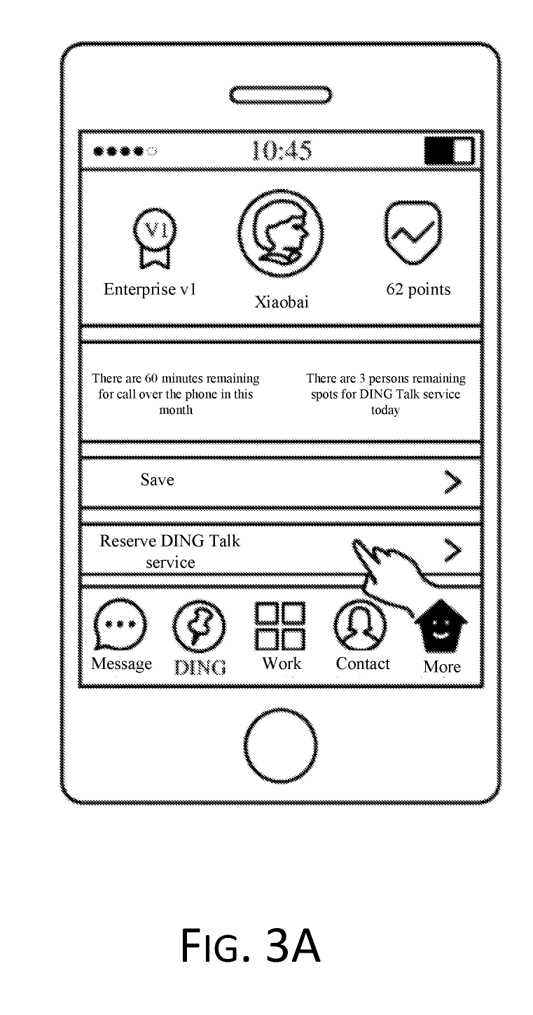

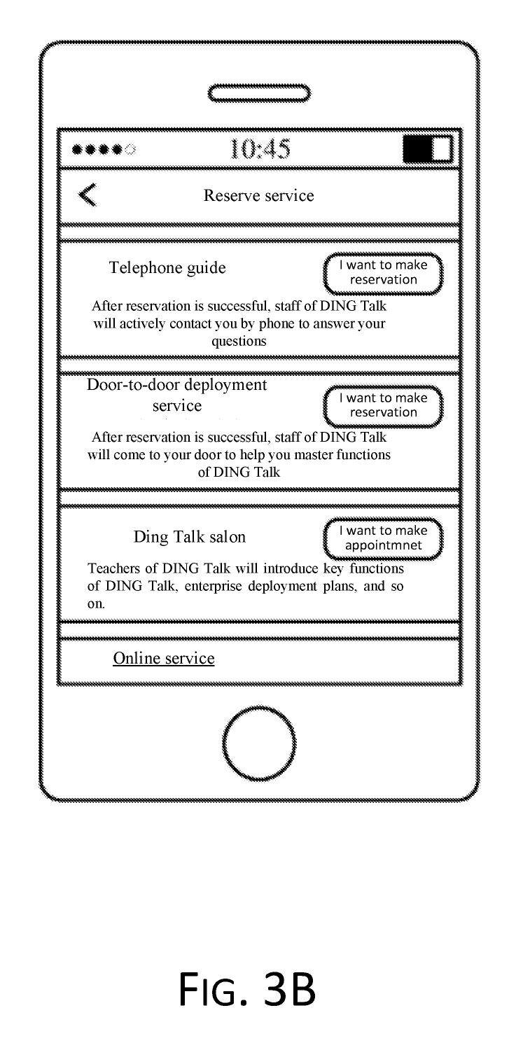

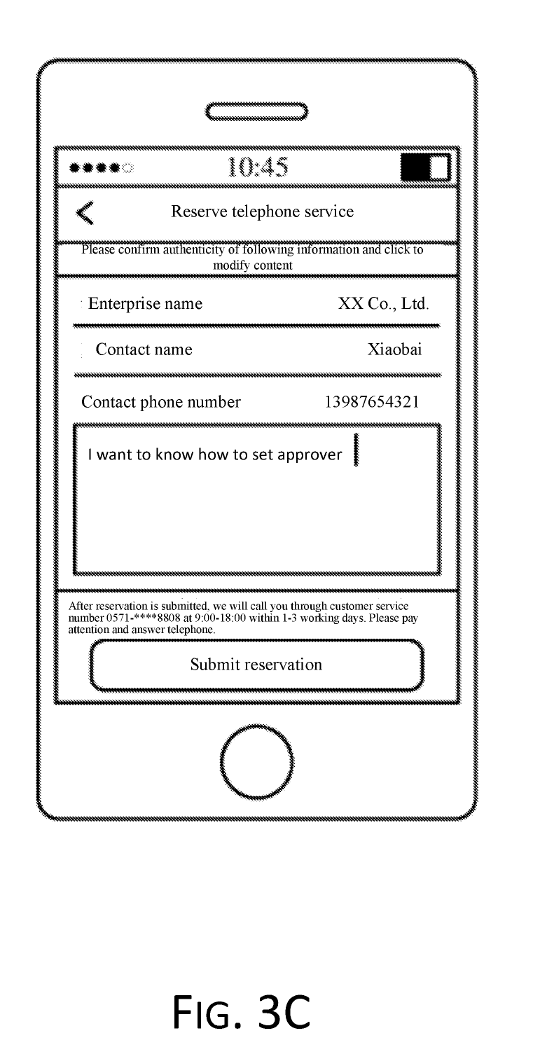

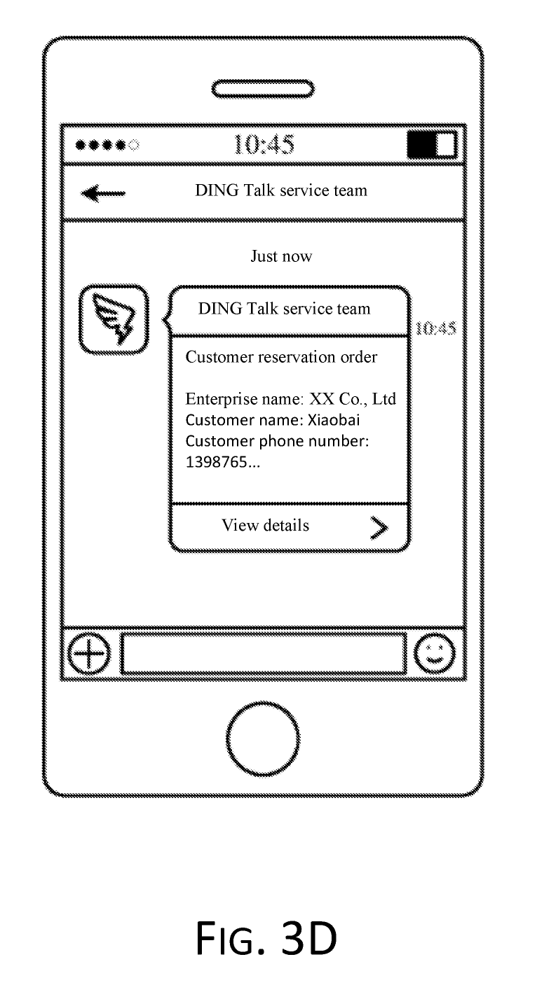

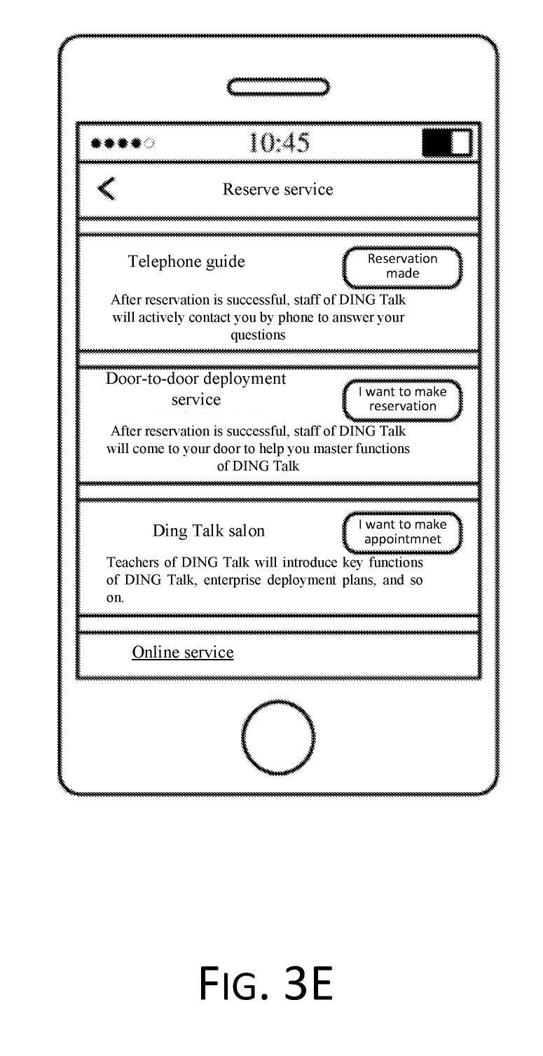

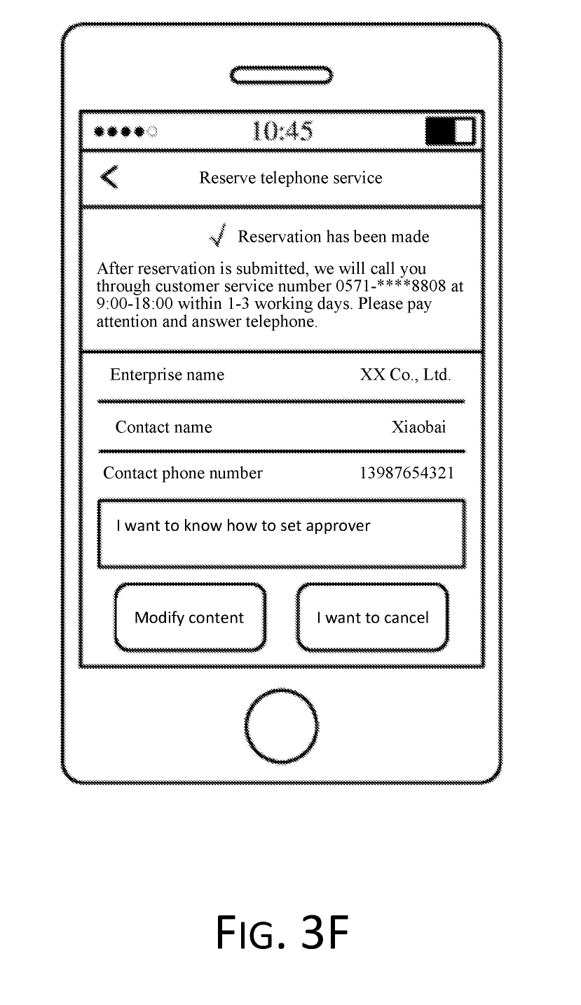

In this embodiment, as shown in FIG. 3A, the “DING Talk” application may include multiple label pages such as “message”, “DING”, “work”, “contact”, and “mine”. For example, the entry to the reservation interface may be added to the label page of “mine”, such as a “reserve a DING service” function item shown in FIG. 3A.

By taking the user “Xiaobai” shown in FIG. 3A as an example, assuming that the user “Xiaobai” initiates a reservation for a teaching service of a preset application function of “DING Talk” in his/her own name, after the user “Xiaobai” triggers the “reserve a DING service” function item shown in FIG. 3A, the reservation interface shown in FIG. 3B may be switched to, so that the subsequent reservation operation may be performed.

Step 204: The initiator determines a teaching service mode.

In this embodiment, as shown in FIG. 3B, “DING Talk” may provide teaching service modes such as “telephone guide”, “door-to-door deployment service” and “DING Talk salon”. Certainly, in the technical solution of the present disclosure, the teaching service mode is not limited. For example, in addition to “telephone guide”, an offline remote communication service type in another form such as “video guide” may also be used. Moreover, in addition to “door-to-door deployment service” and “DING Talk salon”, an offline face-to-face teaching service type in another form such as “DING Talk mutual-help group” may also be used. Besides, in addition to the above “offline” teaching service modes, as shown in FIG. 3B, a teaching service of an online service type such as “online service” may also be provided.

Step 206: A server receives a telephone reservation request initiated by the initiator.

In this embodiment, a solution of reserving a teaching service in the present disclosure is described by taking “telephone guide” as an example. As shown in FIG. 3C, the user “Xiaobai” serving as the initiator needs to enter his/her own information, so that the service provider may call the user “Xiaobai” to achieve the teaching service. The user “Xiaobai” should at least provide his/her own “contact phone number” or other telephone contact manners, and certainly, may also further provide information such as “enterprise name” and “contact name”, so that the service provider may get hold of the initiator. The user “Xiaobai” may manually enter the above information. Alternatively, if the user “Xiaobai” has logged onto his/her own account on a terminal, “DING Talk” may directly read contact information of the user “Xiaobai” and automatically fill the contact information in corresponding information items in FIG. 3C.

As shown in FIG. 3C, in addition to the user information of the initiator, the initiator may further enter a question to be consulted in a message box, such as “I want to know how to set the approver”, so as to facilitate the service provider to understand and make related work preparations in advance, or to facilitate the server to arrange a proper service provider (such as a service provider who is relatively more familiar with “set the approver”) for a consulting item of “set the approver”.

Step 208: The server selects the service provider.

In this embodiment, the server may automatically select at least one service provider from preset service providers corresponding to the teaching service mode selected by the initiator. Then, corresponding to the embodiment shown in FIG. 2, it is equivalent to that the server selects, from all service providers that provide a teaching service of “telephone guide”, a service provider who provides a telephone teaching service to the user “Xiaobai” serving as the initiator.

The server may adopt any selection manner. For example, the server may select, randomly or according to a preset order, a service provider from all idle service providers who may provide a telephone teaching service. Alternatively, the server may select a proper service provider according to the manner mentioned above, i.e., according to a consulting requirement entered by the initiator such as “I want to know how to set the approver”. The manner may be referred to as “distribution according to needs”. Certainly, for the manner of “distribution according to needs”, it is also possible to select, according to a preset feature attribute of the initiator, at least one service provider from preset service providers corresponding to the teaching service mode selected by the initiator, wherein the preset feature attribute may include at least one of the following:

1) Age. On one hand, users in different age groups may have different teaching requirements. For example, users in a lower age group may be more inclined to some novel application functions, and users in a higher age group may be more inclined to some basic application functions. On the other hand, the users in different age groups may have different acceptance levels of teaching. For example, the users in the higher age group may be slightly weak in such aspects as mental flexibility and comprehension ability, and require service providers having a higher level of teaching ability.

2) Location, i.e., a real-time geographical position of the initiator. Users may be in various countries or in various regions of the same country. Although the telephone teaching service is less affected by the geographical position, a proper service provider should be selected correspondingly based on influences of language habits, dialects and other factors to minimize possible problems such as the resulting communication barriers.

3) Group scale. It may be determined according to the scale of a group whether it is necessary to increase or decrease the number of service providers. Especially, it may be necessary to arrange experienced service providers for a larger-scale group, so as to provide a better teaching service.

It should be noted that the service provider may be a company employee provided by the developer of “DING Talk”. Or, the service provider may also be an ordinary user who is familiar with related application functions of “DING Talk”, such as “fans” or “senior fans” recruited from a virtual community related to “DING Talk”. Or, the service provider may further be from any other source, as long as the service provider may provide the corresponding teaching service, which is not limited in the present disclosure.

Step 210: The server sends a teaching service instruction to the selected service provider, and notifies the initiator of a reservation result.

In this embodiment, the server may send a communication message including a teaching service instruction to the service provider through “DING Talk”. For example, the communication message may be an instant messaging message, an email, a text message, or a telephone reminder implemented via a “DING” function provided by the “DING” label page shown in FIG. 3A, which is not limited in the present disclosure. As shown in FIG. 3D, all the service providers may be added to a group such as “DING Talk service group”. The selected service provider may receive a notification message from the “DING Talk service group” (or another sender) on the terminal, and obtains reservation information of the user “Xiaobai” serving as the initiator.

In this embodiment, the server may notify the user “Xiaobai” of the reservation result after the user “Xiaobai” serving as the initiator completes a reservation operation. As shown in FIG. 3E, the user “Xiaobai” may see, in a reservation interface of “DING Talk”, the tag at “telephone guide” has changed from “I want to make a reservation” shown in FIG. 3B to “I have made a reservation”. At the same time, after the user “Xiaobai” triggers a function option of “telephone guide”, a reservation result query page shown in FIG. 3F may be switched to, for viewing reservation information related to “telephone guide”. Certainly, the user “Xiaobai” may also receive a communication message related to the reservation result in a manner similar to the above “teaching service instruction”, which is not described in detail here.

Step 212: The server receives a confirmation message sent by the service provider.

In this embodiment, the service provider may accept or reject a teaching service reservation allocated by the server. Then, after receiving the confirmation message returned by the service provider, the server needs to determine a service provider that finally provides the initiator with a teaching service. If the service provider rejects the teaching service reservation allocated by the server, e.g., the service provider is not good at teaching a related application function, the server may allocate another service provider to the initiator. The confirmation process of the service provider, the process of reallocating the service provider by the server and the like do not require participation of the initiator. Therefore, the processes may be invisible to the initiator, so that the initiator may feel that “the reservation process is very convenient”, being helpful to improve use experience of the user.

Certainly, in another scenario, the service provider may not have the right to reject the teaching service reservation allocated by the server, so the foregoing Step 212 may be omitted.

Step 214: A telephone teaching service is completed between the initiator and the service provider.

In this embodiment, before Step 214, as shown in FIG. 3F, the initiator may initiate a configuration request for a corresponding teaching service by triggering “modify the content” or “I want to cancel”, and then the server may update or cancel the corresponding teaching service according to the configuration request.

For example, upon completion of the reservation, the user “Xiaobai” serving as the initiator may trigger “modify the content” as shown in FIG. 3F and edit the content that has been entered, such as “enterprise name”, “contact name”, and “contact phone number”. Therefore, after the initiator confirms all the edited content, the server may receive a corresponding configuration request and complete updating for the teaching service.

Upon completion of the reservation, the user “Xiaobai” serving as the initiator may trigger “I want to cancel” shown in FIG. 3F to cancel the reservation that has been created but has not yet obtained a teaching service. If the operation of canceling the reservation is completed, it is equivalent to that the reservation result changes. Thus, the initiator may be notified of the changed reservation result in a manner similar to Step 210, which is not described in detail here.

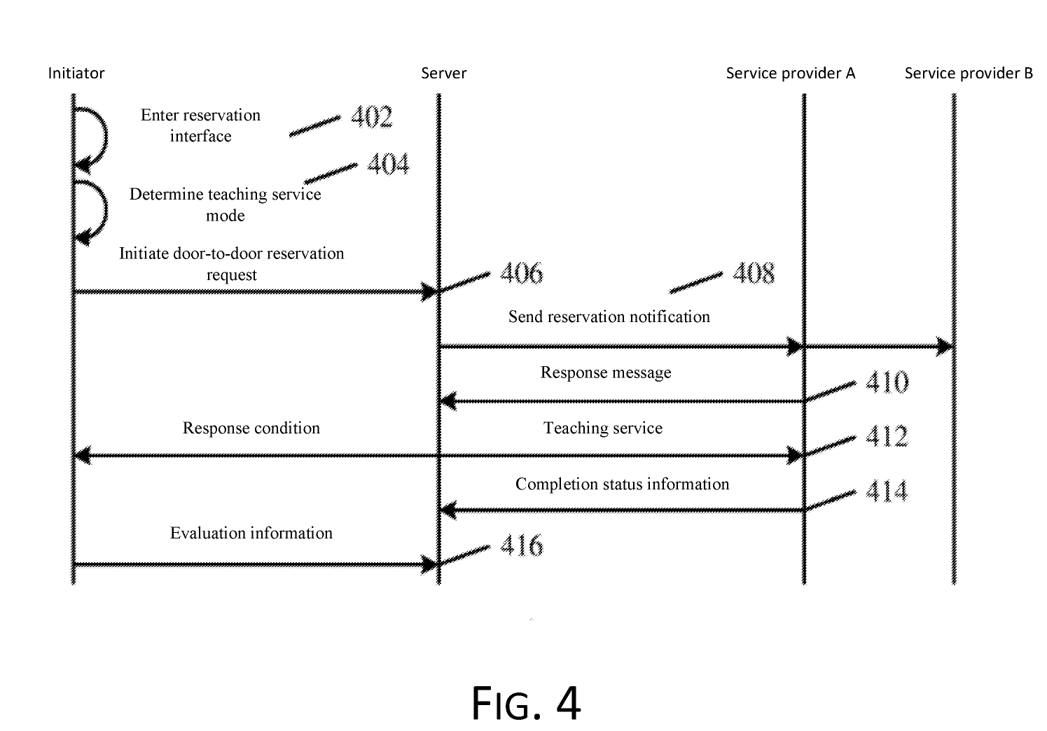

FIG. 4 is a flowchart of another teaching reservation service according to an example embodiment of the present disclosure. As shown in FIG. 4, the process may include the following steps:

Step 402: An initiator enters a reservation interface.

Step 404: The initiator determines a teaching service mode.

In this embodiment, reference may be made to Steps 202 to 204 shown in FIG. 2 for Steps 402 to 404, which are not described in detail here.

Step 406: A server receives a door-to-door reservation request initiated by the initiator.

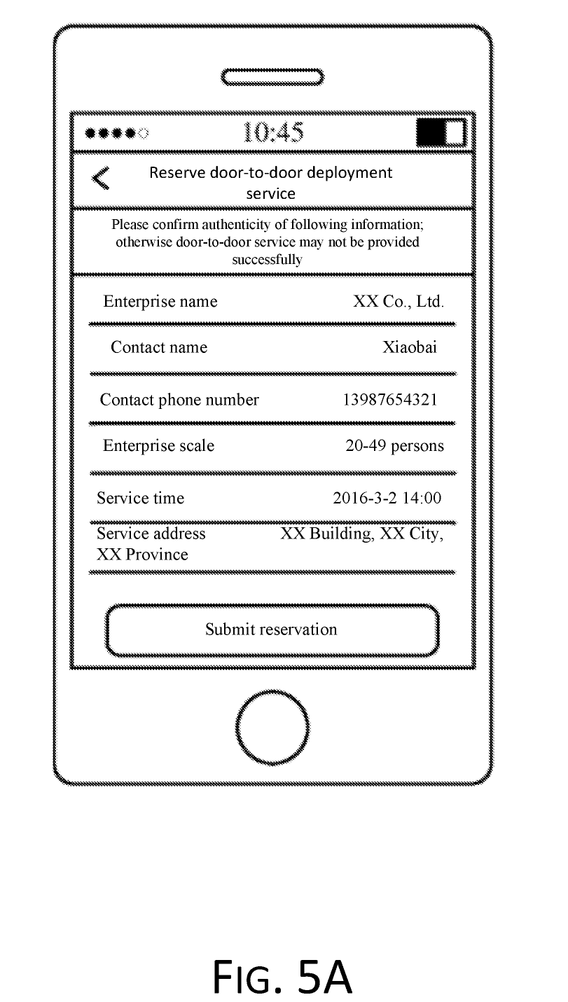

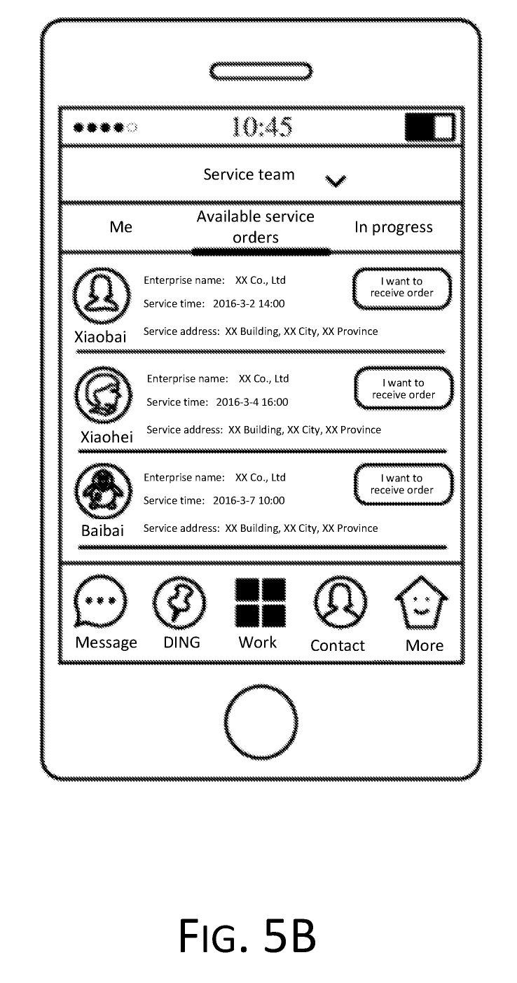

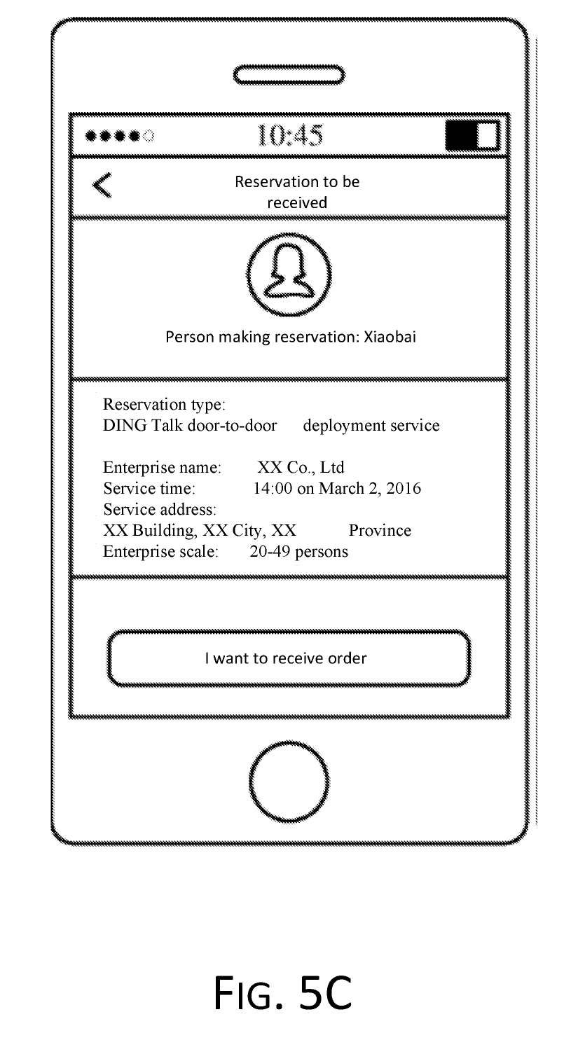

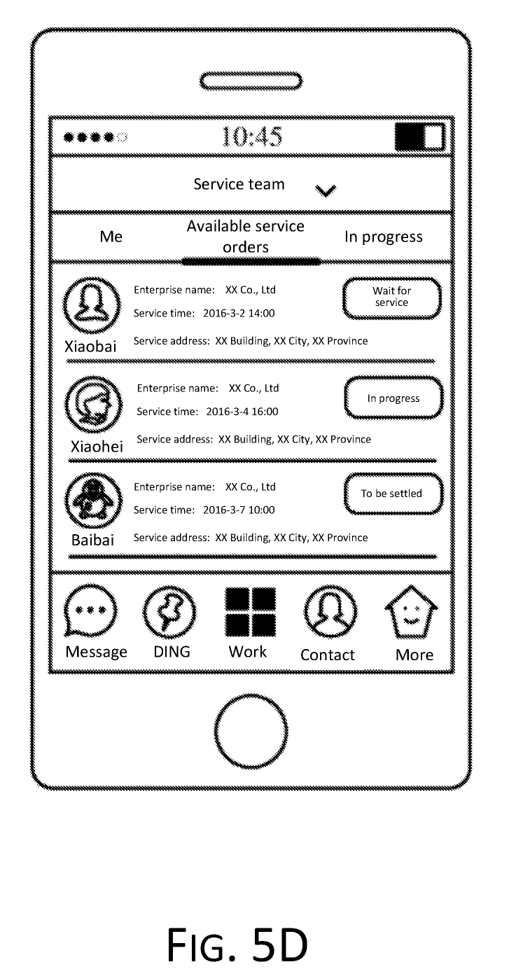

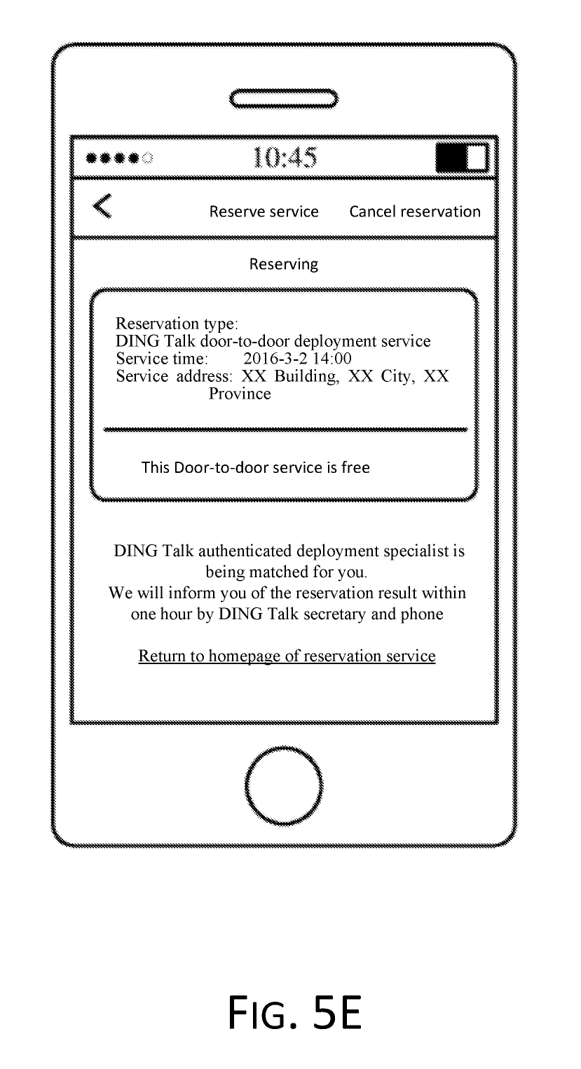

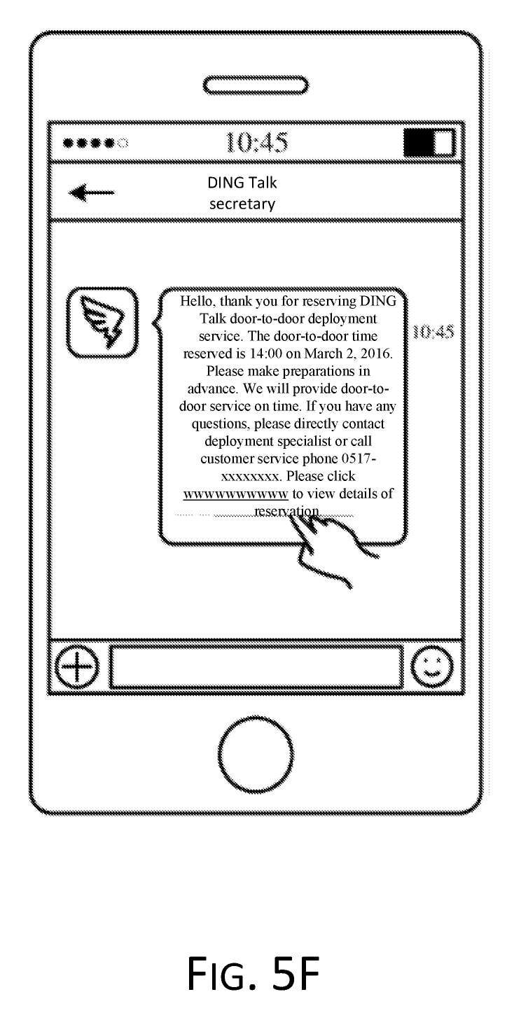

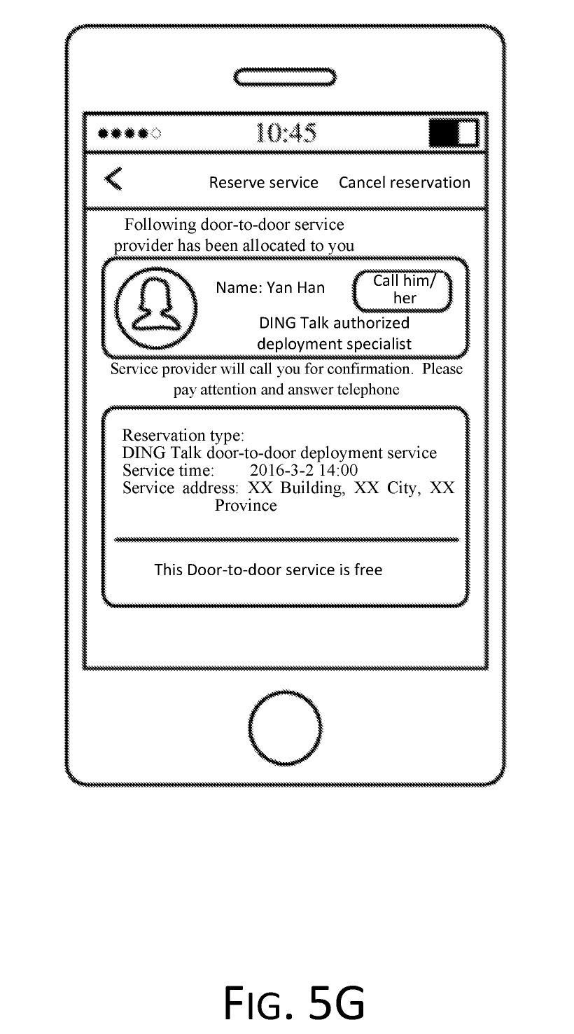

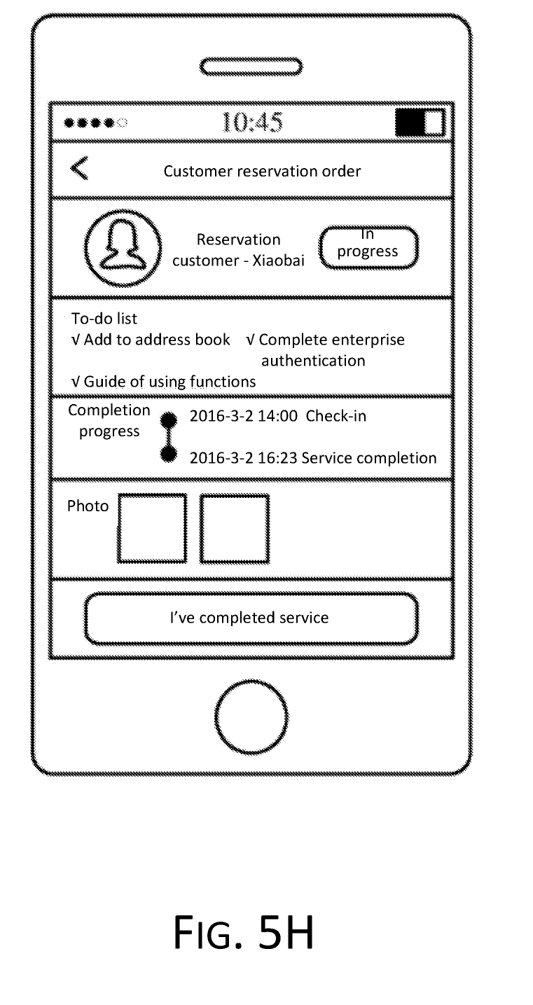

In this embodiment, assuming that the user “Xiaobai” serving as the initiator selects the “door-to-door deployment service” shown in FIG. 3B, the user “Xiaobai” may provide information including “enterprise name”, “contact name”, “contact phone number”, “enterprise scale”, “service time”, “service address” and the like or other types of information through the page as shown in FIG. 5A, so that the service provider provides the door-to-door deployment service accordingly. After the initiator triggers “submit a reservation” at the bottom of FIG. 5A, a “DING Talk” client terminal used by the initiator initiates to the server a request for reserving a door-to-door deployment service.

Step 408: The server sends a reservation notification associated with the reservation request to a service provider of preset service providers corresponding to the teaching service mode selected by the initiator.

Step 410: The server receives a response message for the reservation notification from a service provider A.

Step 412: The server sends a teaching service instruction associated with the reservation request to the service provider, and returns a response condition to the initiator.

In this embodiment, it is assumed that a service provider A, a service provider B and so on exist at the same time and they all may provide a door-to-door deployment service. Then, in the embodiment shown in FIG. 4, the server may send a reservation notification to all of the service providers that may provide the door-to-door deployment service, e.g., the service provider A, the service provider B and so on, respectively. The service providers determine, after viewing and making selections on their own, whether to provide the corresponding requester with the door-to-door deployment service.

In this embodiment, as shown in FIG. 5B, the service provider may view all current reservation notifications by clicking “available service orders”. After the service provider clicks the tag of “I'm at your service”, the service provider may enter an order receiving page shown in FIG. 5C and further achieve an order receiving operation by clicking “I want to receive this order”. In the order receiving page shown in FIG. 5C, the service provider may view information provided by the initiator such as “enterprise name”, “contact name”, “contact phone number”, “enterprise scale”, “service time”, and “service address”, and accordingly determine whether it is necessary to perform “order receiving” by triggering “I want to receive this order” at the bottom of the interface, i.e., whether it is intended to provide the corresponding initiator with a door-to-door deployment service.

In one case, the server may send a teaching service instruction to each service provider who returns a response message, so that the service providers may provide the corresponding initiator with a door-to-door deployment service. In another case, there may be a lot of service providers who return a response message, and the number of the service providers who return a response message is more than the number of the service providers actually required by the initiator. At this point, it is necessary to screen service providers from the service providers who return a response message.

When service providers are screened from the service providers who return a response message, a principle of “receiving an order preemptively” may be adopted: the teaching service instruction associated with the reservation request is sent, according to a response order of the multiple service providers, to a preset number of service providers responding earlier. For example, assuming that a total of two service providers are needed while response messages returned by ten service providers are received, the service providers may be arranged according to a response sequence of the service providers in order, and service providers who return a response message first and second are selected. Then, the selected service providers may view an order that has been received preemptively from “in progress” shown in FIG. 5D. For example, on the top of FIG. 5D is the order corresponding to the teaching service shown in FIG. 5C.

In this embodiment, as the order receiving, judgment and other processes of the service provider need certain processing time, “DING Talk” may switch to the waiting page shown in FIG. 5E after the initiator initiates a door-to-door reservation request in step 406. Certainly, the initiator does not actually need to hold the waiting in the waiting page but may perform any other operation. However, the server may notify the initiator of the corresponding response condition (which may include: whether a response is made, all service providers making a response, a selected service provider, success or failure of a final reservation result, and the like). For example, in FIG. 5F, a notification message for successful reservation may be sent through “Secretary Ding”, and after the initiator clicks the link in the notification message, the initiator may view information related to the teaching service such as the allocated service provider in the page shown in FIG. 5G.

Step 414: The server receives completion status information uploaded by the service provider about the teaching service associated with the reservation request.

In this embodiment, when the service provider provides the initiator with the teaching service, the service provider may upload related completion status information to the server as corresponding evidence information or historical data. As shown in FIG. 5H, the completion status information may include at least one of the following: sign-in information, completion progress information, teaching content, a group photo with the initiator, and so on.

In this embodiment, the server may allocate a corresponding preset transaction object to the service provider according to the received completion status information to serve as remuneration or reward for the service provider. For example, the preset transaction object may include real articles, and may also include virtual articles such as funds, vouchers and virtual props.

Step 416: The server receives evaluation information for the obtained teaching service from the initiator of the reservation request.

In this embodiment, the server may reward or punish, according to the received evaluation information, the service provider providing the corresponding teaching service. For example, when the initiator proposes a high evaluation or when a preset number of initiators all propose a high evaluation to the service provider, the service provider may be rewarded, for example, improve the quota of the preset transaction object, promote the teaching level of the service provider, and the like. When the initiator proposes a low evaluation or when a preset number of initiators all propose a low evaluation to the service provider, the quota of the preset transaction object may be reduced, the teaching level of the service provider may be reduced, and so on.

It should be noted that:

Although the manner of “allocating a service provider” is adopted in the embodiment shown in FIG. 2 and the manner of “receiving an order preemptively” is adopted in the embodiment shown in FIG. 4, each manner may actually be applied in all the embodiments of the technical solution of the present disclosure. That is, the service provider providing a teaching service may also be determined in the manner of “receiving an order preemptively” in the embodiment shown in FIG. 2, and the service provider providing a teaching service may also be determined in the manner of “allocating a service provider” in the embodiment shown in FIG. 4. For example, when the manner of “allocating a service provider” is adopted in the embodiment shown in FIG. 4, for offline face-to-face teaching service such as a “door-to-door deployment service”, a proper service provider may be selected according to whether a corresponding teaching service has been carried out locally, a distance between locations of each service provider and the initiator, and the like, so that the initiator may be provided with the corresponding door-to-door deployment service or other teaching services.

Certainly, other manners for determining the service provider providing a teaching service that are not described in detail above may all be applied to the embodiments of the technical solution of the present disclosure, which are not limited in the present disclosure.

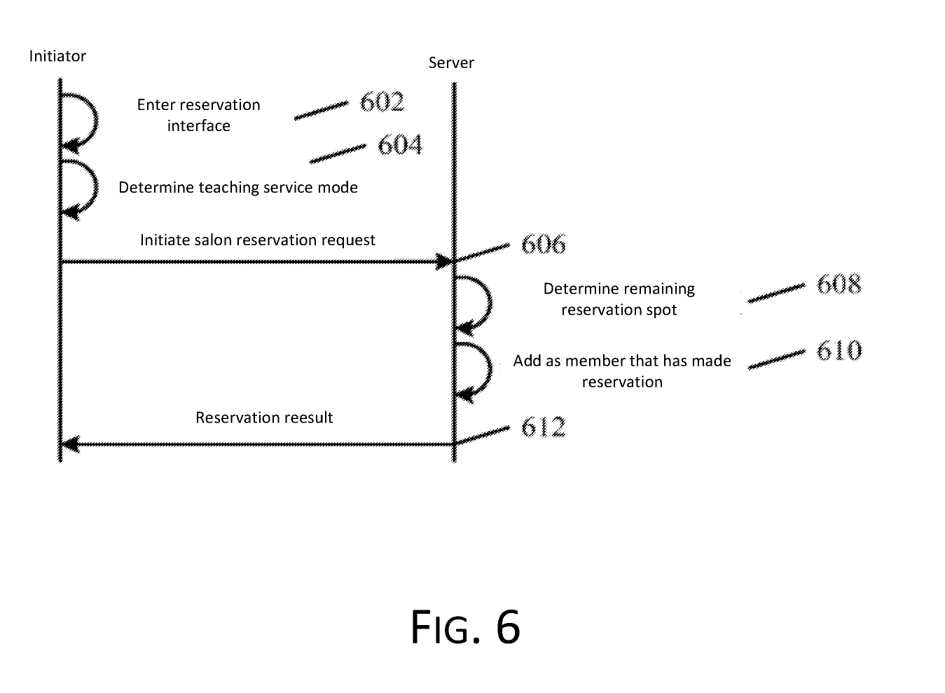

FIG. 6 is a flowchart of a yet another teaching reservation service according to an example embodiment of the present disclosure. As shown in FIG. 6, the process may include the following steps:

Step 602: An initiator enters a reservation interface.

Step 604: The initiator determines a teaching service mode.

In this embodiment, reference may be made to Steps 202 to 204 shown in FIG. 2 for Steps 602 to 604, which are not described in detail here.

Step 606: A server receives a salon reservation request initiated by the initiator.

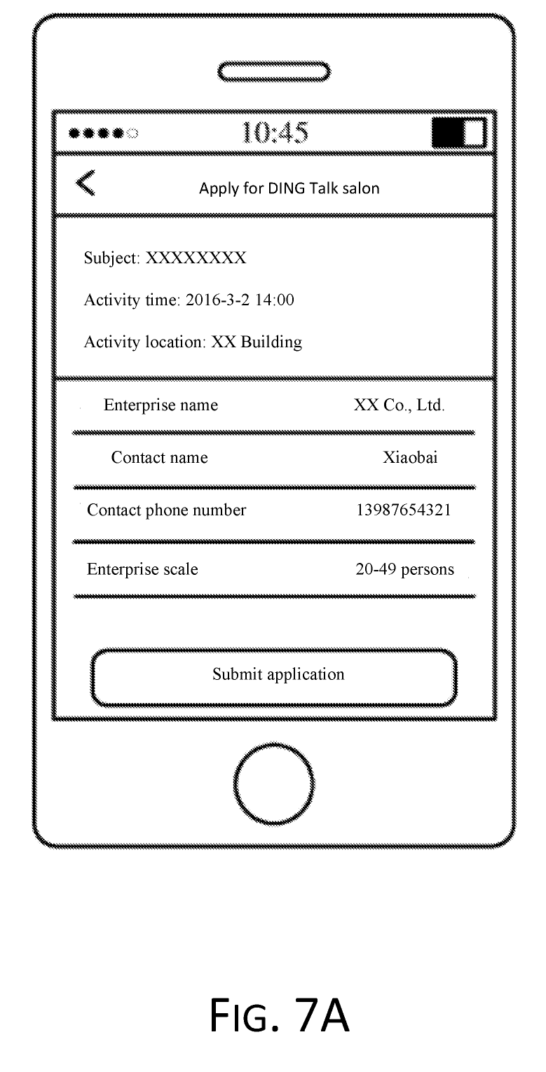

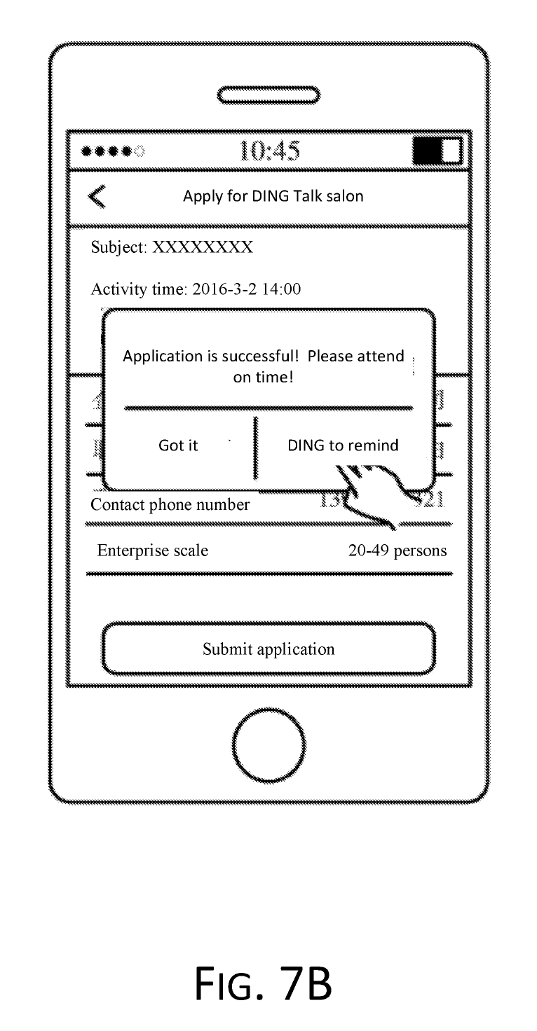

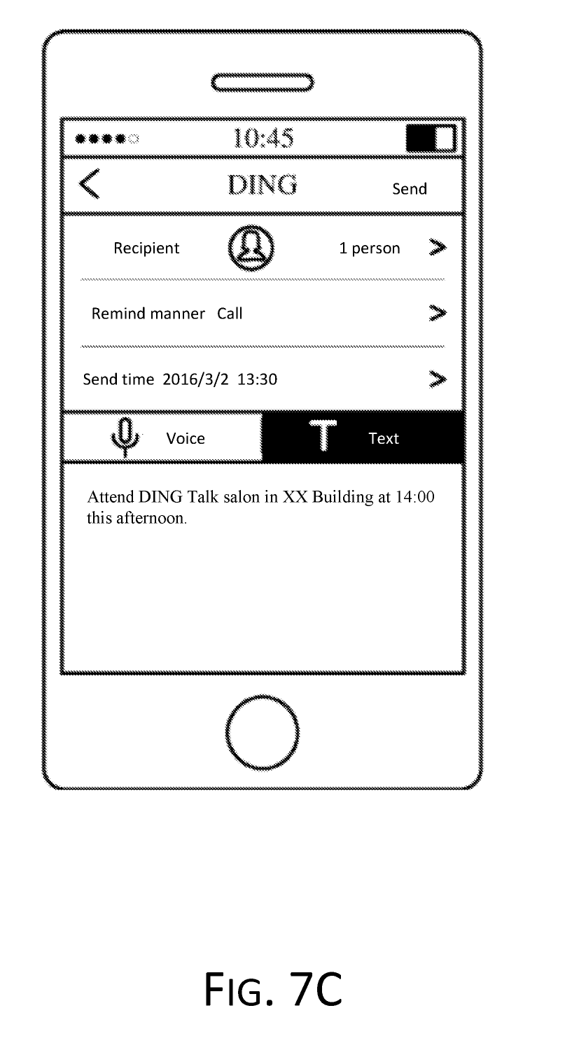

In this embodiment, assuming that the user “Xiaobai” serving as the initiator selects the “DING Talk salon” shown in FIG. 3B, the user “Xiaobai” may provide information including “enterprise name”, “contact name”, “contact phone number”, “enterprise scale”, and the like or other types of information through the page as shown in FIG. 7A. After the initiator triggers “submit an application” at the bottom of FIG. 7A, a “DING Talk” client terminal used by the initiator initiates to the server a request for reserving a DING Talk salon. Alternatively, as the “DING Talk salon” actually may be understood as a teaching meeting, it may also be referred to as an “application request”, that is, applying for participating in the teaching meeting.

Step 608: The server determines whether there is a remaining reservation spot for the DING Talk salon.

Step 610: When there is a remaining reservation spot, the server adds the initiator of the reservation request as a member that has made a reservation for the DING Talk salon.

Step 612: The server notifies the initiator of a reservation result.

In this embodiment, a teaching meeting such as “DING Talk salon” requires the initiator to go to a corresponding place at a corresponding time for participation; therefore, after the application (i.e., reservation) is successful, a setting option of “DING to remind” as shown in FIG. 7B may be provided. After the initiator triggers the setting option, a reminder message configuration page shown in FIG. 7C may be switched to and a reminder message for the teaching meeting such as “DING Talk salon” is configured to prevent the initiator from missing the corresponding teaching service.

In any of the foregoing embodiments of the present disclosure, the preset condition of the initiator may also be checked and validated to determine whether the initiator is allowed to initiate a reservation request. For example, after any user uses a “DING Talk” application on his/her terminal, e.g., the user clicks “I want to make a reservation” or “I want to make an application” shown in FIG. 3B, the “DING Talk” application on the terminal may acquire a preset feature attribute of the any user and allow the user to initiate a reservation request only when the preset feature attribute meets at least one of the following conditions:

the location of the any user belongs to a preset region, the creation date of a team to which the any user belongs is within a preset time length, the number of members of the team to which the any user belongs is not less than a preset number, and an administrative permission level of the any user in the team reaches a preset level.

In addition, in any of the foregoing embodiments of the present disclosure, the method may further include: acquiring office efficiency indication information, the office efficiency indication information being associated with usage of an office management function in the preset instant messaging application by at least one of a current user and users associated with the current user. When the office efficiency indication information corresponds to predefined low office efficiency, initiating, by the preset instant messaging application, a reservation reminder for the preset service to at least one of the current user and the users associated with the current user, wherein the preset service is associated with improvement of office efficiency.

By taking “DING Talk” as an example, “DING Talk” provides office management functions such as a contact management function, a communication function and a group management function, and may obtain corresponding office efficiency indication information according to the usage of these office management functions by the current user. For example, the usage of these office management functions by the current user may include “degree of historical usage”. Then, the conventional office manner requires a connection to a dedicated management system of an enterprise (or another group), which greatly limits system access, management implementation, usage range and so on; therefore, the office efficiency may be improved significantly by making more use of a preset application that includes the above office management functions. It may be considered that the office efficiency is positively correlated with the degree of the usage of the preset application by the user. Then, when the office efficiency indication information includes: an office efficiency indication parameter and the value of the office efficiency indication parameter, it may be considered that the value of the office efficiency indication parameter is positively correlated with the degree of historical usage. For example, the value of an office efficiency indication parameter corresponding to the user “Xiaobai” serving as a current user is shown in the top right corner of an interface shown in FIG. 3A, i.e., “62 points”.

Therefore, when the value of the office efficiency indication parameter is less than a preset value, it may be determined that the office efficiency indication information corresponds to a predefined low office efficiency, and this is possibly caused by that the current user is unfamiliar with the corresponding office management function. Thus, a reservation reminder for a teaching service for the related office management function may be initiated to the current user to help the current user initiate a reservation request for a corresponding teaching service in the case of the unfamiliar application function (e.g., the above office management function). Therefore, the current user may understand and learn usage of the related application function through the corresponding teaching service.

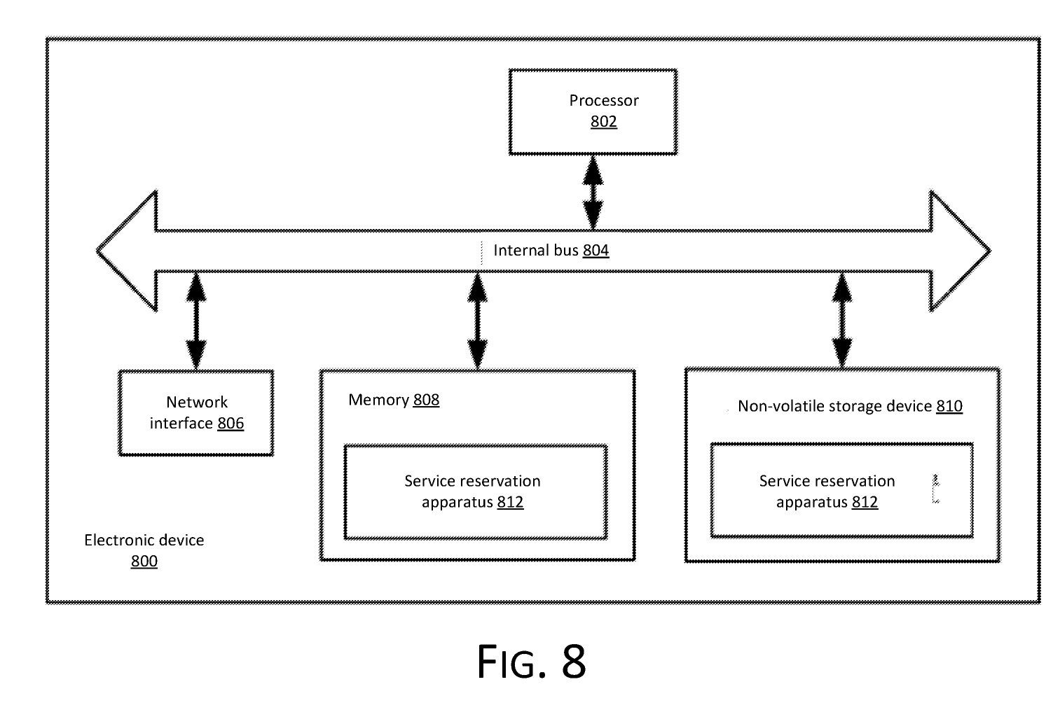

FIG. 8 is a schematic structural diagram of an electronic device according to an example embodiment of the present disclosure. Referring to FIG. 8, at the hardware level, an electronic device 800 includes a processor 802, an internal bus 804, a network interface 806, a memory 808, and a non-volatile storage device 810, and certainly may also include hardware required for other services. The processor 802 reads a corresponding computer program from the non-volatile storage device 810 into the memory and then runs the computer program to form a service reservation apparatus 812 on the logic level. Certainly, in addition to the software implementation manner, the present disclosure does not exclude other implementation manners, such as manners of logic devices or a combination of software and hardware. In other words, the following processing procedures are not limited to be executed by various logic units and may also be executed by hardware or logic devices.

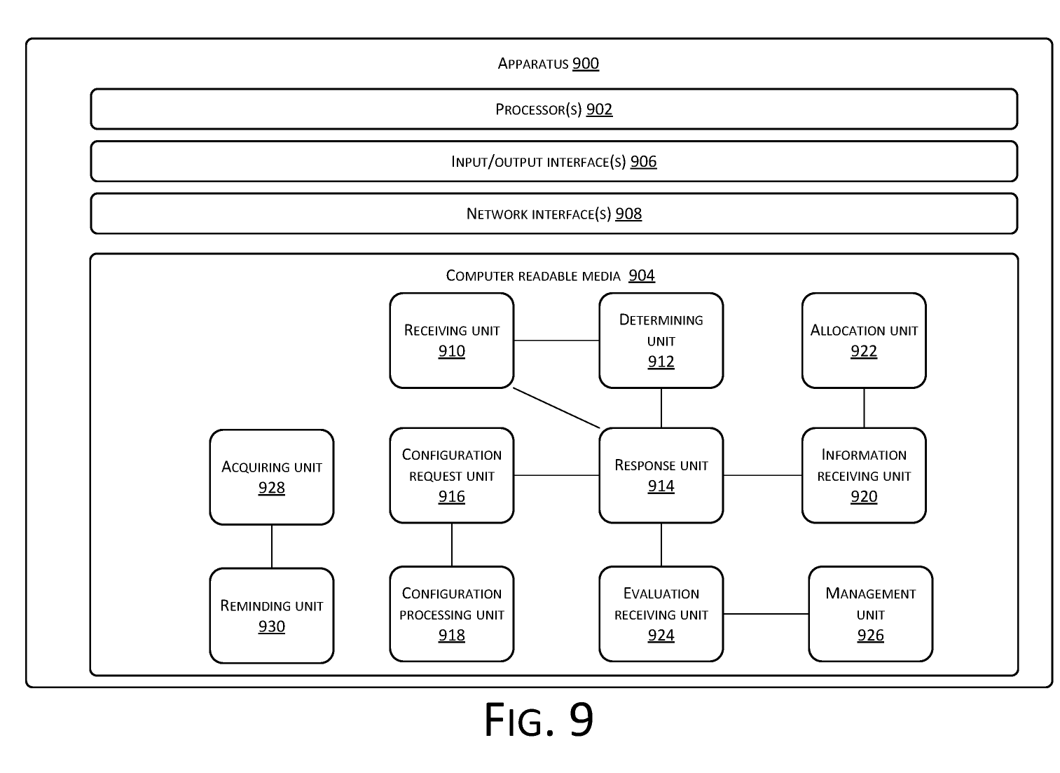

Referring to FIG. 9, an apparatus 900 for reserving a teaching service includes one or more processor(s) 902 or data processing unit(s) and computer readable media 904. The apparatus 900 may further include one or more input/output interface(s) 906 and one or more network interface(s) 908.

The computer readable media 904 may store therein a plurality of modules or units including a receiving unit 910, a determining unit 912 and a response unit 914.

The receiving unit 910 is configured to receive a reservation request for a preset service initiated by a preset instant messaging application.

The determining unit 912 is configured to determine a service mode designated by the reservation request.

The response unit 914 is configured to make a response to the reservation request according to the service mode to enable an initiator of the reservation request to obtain the preset service.

Optionally, the service mode includes at least one of the following: an online service type, an offline remote communication service type, and an offline face-to-face teaching service type.

Optionally, the response unit 914 is specifically configured to:

select at least one service provider from preset service providers corresponding to the service mode; and

send a service instruction associated with the reservation request to the service provider, so that the initiator of the reservation request obtains the preset service after the service provider executes the service instruction.

Optionally, the response unit 914 selects at least one service provider from the preset service providers corresponding to the service mode in the following manner:

when the reservation request includes a preset feature attribute of the initiator of the reservation request or a service requirement input by the initiator, selecting, according to the preset feature attribute or the service requirement, at least one service provider from the preset service providers corresponding to the service mode, wherein the preset feature attribute includes at least one of the following: age, location, and group scale.

Optionally, the response unit 914 is specifically configured to:

send a reservation notification associated with the reservation request to service providers of the preset service providers corresponding to the service mode; and

when a response message for the reservation notification from any service provider is received, send a service instruction associated with the reservation request to the any service provider, so that the initiator of the reservation request obtains the preset service after the any service provider executes the service instruction.

Optionally, the response unit 914 is further configured to:

when response messages for the reservation notification from multiple service providers are received, send, according to a response order of the multiple service providers, the service instruction associated with the reservation request to a preset number of service providers responding earlier.

Optionally, the response unit 914 is further configured to:

acquire a response condition of the reservation notification, and send the response condition to the initiator of the reservation request.

Optionally, the response unit 914 is specifically configured to:

determine, when the service mode is a meeting of an offline face-to-face teaching service type, whether there is a remaining reservation for the meeting; and

add, when there is a remaining reservation for the meeting, the initiator of the reservation request as a member that has made a reservation for the meeting.

Optionally, the initiator of the reservation request meets at least one of the following predefined reservation permission conditions:

the location of the initiator belongs to a preset region, the creation date of a team to which the initiator belongs is within a preset time length, the number of members of the team to which the initiator belongs is not less than a preset number, and an administrative permission level of the initiator in the team reaches a preset level.

Optionally, the apparatus 900 further includes the following units stored on the computer readable media 904:

a configuration request unit 916 configured to receive a configuration request for the preset service from the initiator of the reservation request; and

a configuration processing unit 918 configured to configure the preset service according to the editing request to update or cancel the preset service.

Optionally, the apparatus 900 further includes the following units stored on the computer readable media 904:

an information receiving unit 920 configured to receive completion status information uploaded by a service provider about the preset service associated with the reservation request;

and an allocation unit 922 configured to allocate a corresponding preset transaction object to the service provider according to the completion status information.

Optionally, the apparatus 900 further includes the following units stored on the computer readable media 904:

an evaluation receiving unit 924 configured to receive evaluation information for the obtained preset service from the initiator of the reservation request; and

a management unit 926 configured to reward or punish, according to the evaluation information, the service provider providing the preset service.

Optionally, the preset service includes: a teaching service for a preset application function of the preset instant messaging application.

Optionally, the preset instant messaging application is an enterprise instant messaging application.

Optionally, the apparatus 900 further includes the following units stored on the computer readable media 904:

an acquiring unit 928 configured to acquire office efficiency indication information, the office efficiency indication information being associated with usage of an office management function in the preset instant messaging application by at least one of a current user and users associated with the current user; and a reminding unit 930 configured to, when the office efficiency indication information corresponds to predefined low office efficiency, initiate a reservation reminder for the preset service to at least one of the current user and the users associated with the current user by the preset instant messaging application, wherein the preset service is associated with improvement of office efficiency.

In a typical configuration, the computer device includes one or more processors (CPU), an input/output interface, a network interface, and a memory.

The memory may include a volatile memory, a random access memory (RAM) and/or a non-volatile storage device or the like in a computer readable medium, for example, a read only memory (ROM) or a flash RAM. The memory is an example of the computer readable medium.

The computer readable medium includes non-volatile and volatile media as well as movable and non-movable media, and may implement information storage by means of any method or technology. Information may be a computer readable instruction, a data structure, a module of a program, or other data. A storage medium of a computer includes, for example, but is not limited to, a phase change memory (PRAM), a static random access memory (SRAM), a dynamic random access memory (DRAM), other types of RAMs, a ROM, an electrically erasable programmable read-only memory (EEPROM), a flash memory or other memory technologies, a compact disk read only memory (CD-ROM), a digital versatile disc (DVD) or other optical storages, a cassette tape, a magnetic tape/magnetic disk storage or other magnetic storage devices, or any other non-transmission medium, and may be used to store information accessible to the computing device. According to the definition in this text, the computer readable medium does not include transitory media, such as modulated data signals and carriers.

It should be further noted that the terms “include”, “comprise” or other variations thereof are intended to cover non-exclusive inclusion, so that a process, method, commodity or device including a series of elements not only includes the elements, but also includes other elements not clearly listed, or further includes elements inherent to the process, method, commodity or device. In the absence of more limitations, an element defined by “including a/an . . . ” does not exclude that the process, method, commodity or device including the element further has other identical elements.

The foregoing are only example embodiments of the present disclosure, which are not intended to limit the present disclosure. Any modifications, equivalent replacements, improvements and the like made with the spirit and principle of the present disclosure should be included in the protection scope of the present disclosure.

The present disclosure may further be understood with clauses as follows.

Clause 1. A service reservation method comprising:

receiving a reservation request for a preset service initiated via a preset instant messaging application;

determining a service mode designated by the reservation request; and

responding to the reservation request according to the service mode to enable an initiator of the reservation request to obtain the preset service.

Clause 2. The method of clause 1, wherein the service mode comprises at least one of the following:

an online service type;

an offline remote communication service type; and

an offline face-to-face teaching service type.

Clause 3. The method of clause 1, wherein the responding to the reservation request according to the service mode comprises:

selecting at least one service provider from preset service providers corresponding to the service mode; and

sending a service instruction associated with the reservation request to a respective service provider, so that the initiator of the reservation request obtains the preset service after the respective service provider executes the service instruction.

Clause 4. The method of clause 3, wherein the selecting at least one service provider from the preset service providers corresponding to the service mode comprises:

when the reservation request comprises a preset feature attribute of the initiator of the reservation request or a service requirement input by the initiator, selecting, according to the preset feature attribute or the service requirement, the at least one service provider from the preset service providers corresponding to the service mode, wherein the preset feature attribute comprises at least one of the following: an age;
a location; and a group scale.

Clause 5. The method of clause 1, wherein the responding to the reservation request according to the service mode comprises:

sending a reservation notification associated with the reservation request to a service provider of preset service providers corresponding to the service mode; and

when a response message for the reservation notification from the service provider is received, sending a service instruction associated with the reservation request to the service provider, so that the initiator of the reservation request obtains the preset service after the service provider executes the service instruction.

Clause 6. The method of clause 5, wherein the responding to the reservation request according to the service mode further comprises:

when response messages for the reservation notification from multiple service providers are received, sending, according to a response order of the multiple service providers, the service instruction associated with the reservation request to a preset number of service providers.

Clause 7. The method of clause 5, wherein the responding to the reservation request according to the service mode further comprises:

acquiring a response condition of the reservation notification; and

sending the response condition to the initiator of the reservation request.

Clause 8. The method of clause 1, wherein the responding to the reservation request according to the service mode comprises:

determining, when the service mode is a meeting of an offline face-to-face teaching service type, whether there is a remaining reservation spot for the meeting; and

adding, when there is the remaining reservation spot for the meeting, the initiator of the reservation request as a member that has made a reservation for the meeting.

Clause 9. The method of clause 1, wherein the initiator of the reservation request meets at least one of the following predefined reservation permission conditions:

a location of the initiator belongs to a preset region;

a creation date of a team to which the initiator belongs is within a preset time length;

a number of members of a team to which the initiator belongs is not less than a preset number; and

an administrative permission level of the initiator in the team reaches a preset level.

Clause 10. The method of clause 1, further comprising:

receiving a configuration request for the preset service from the initiator of the reservation request; and

configuring the preset service according to an editing request to update or cancel the preset service.

Clause 11. The method of clause 1, further comprising:

receiving completion status information uploaded by a service provider about the preset service associated with the reservation request; and

allocating a corresponding preset transaction object to the service provider according to the completion status information.

Clause 12. The method of clause 1, further comprising:

receiving evaluation information for the obtained preset service from the initiator of the reservation request; and

rewarding or punishing, according to the evaluation information, the service provider providing the preset service.

Clause 13. The method of clause 1, wherein the preset service comprises a teaching service for a preset application function of the preset instant messaging application.

Clause 14. The method of clause 1, wherein the preset instant messaging application is an enterprise instant messaging application.

Clause 15. The method of clause 1, further comprising:

acquiring office efficiency indication information, the office efficiency indication information being associated with usage of an office management function in the preset instant messaging application by at least one of a current user and a user associated with the current user; and when the office efficiency indication information corresponds to a predefined low office efficiency, initiating a reservation reminder for the preset service to at least one of the current user and the users associated with the current user by the preset instant messaging application, wherein the preset service is associated with improvement of office efficiency.

Clause 16. A service reservation apparatus comprising:

a receiving unit configured to receive a reservation request for a preset service initiated by a preset instant messaging application;

a determining unit configured to determine a service mode designated by the reservation request; and

a response unit configured to respond to the reservation request according to the service mode to enable an initiator of the reservation request to obtain the preset service.

Clause 17. The apparatus of clause 16, wherein the service mode comprises at least one of the following:

an online service type;

an offline remote communication service type; and

an offline face-to-face teaching service type.

Clause 18. The apparatus of clause 16, wherein the response unit is specifically configured to:

select at least one service provider from preset service providers corresponding to the service mode; and

send a service instruction associated with the reservation request to a respective service provider, so that the initiator of the reservation request obtains the preset service after the respective service provider executes the service instruction.

Clause 19. The apparatus of clause 18, wherein the response unit selects at least one service provider from the preset service providers corresponding to the service mode in the following manner:

When the reservation request comprises a preset feature attribute of the initiator of the reservation request or a service requirement input by the initiator, selecting, according to the preset feature attribute or the service requirement, at least one service provider from the preset service providers corresponding to the service mode, wherein the preset feature attribute comprises at least one of the following: age, location, and group scale.

Clause 20. The apparatus of clause 16, wherein the response unit is specifically configured to:

send a reservation notification associated with the reservation request to service providers of preset service providers corresponding to the service mode; and

when a response message for the reservation notification from a service provider is received, send a service instruction associated with the reservation request to the service provider, so that the initiator of the reservation request obtains the preset service after the service provider executes the service instruction.

Clause 21. The apparatus of clause 20, wherein the response unit is further configured to:

when response messages for the reservation notification from multiple service providers are received, send, according to a response order of the multiple service providers, the service instruction associated with the reservation request to a preset number of service providers.

Clause 22. The apparatus of clause 20, wherein the response unit is further configured to:

acquire a response condition of the reservation notification; and

send the response condition to the initiator of the reservation request.

Clause 23. The apparatus of clause 16, wherein the response unit is specifically configured to:

determine, when the service mode is a meeting of an offline face-to-face teaching service type, whether there is a remaining reservation for the meeting; and

add, when there is a remaining reservation for the meeting, the initiator of the reservation request as a member that has made a reservation for the meeting.

Clause 24. The apparatus of clause 16, wherein the initiator of the reservation request meets at least one of the following predefined reservation permission conditions:

a location of the initiator belongs to a preset region;

a creation date of a team to which the initiator belongs is within a preset time length;

a number of members of a team to which the initiator belongs is not less than a preset number; and

an administrative permission level of the initiator in the team reaches a preset level.

Clause 25. The apparatus of clause 16, further comprising:

a configuration request unit configured to receive a configuration request for the preset service from the initiator of the reservation request; and

a configuration processing unit configured to configure the preset service according to an editing request to update or cancel the preset service.

Clause 26. The apparatus of clause 16, further comprising:

an information receiving unit configured to receive completion status information uploaded by a service provider about the preset service associated with the reservation request;

and an allocation unit configured to allocate a corresponding preset transaction object to the service provider according to the completion status information.

Clause 27. The apparatus of clause 16, further comprising:

an evaluation receiving unit configured to receive evaluation information for the obtained preset service from the initiator of the reservation request; and

a management unit configured to reward or punish, according to the evaluation information, the service provider providing the preset service.

Clause 28. The apparatus of clause 16, wherein the preset service comprises a teaching service for a preset application function of the preset instant messaging application.

Clause 29. The apparatus of clause 16, wherein the preset instant messaging application is an enterprise instant messaging application.

Clause 30. The apparatus of clause 16, further comprising:

an acquiring unit configured to acquire office efficiency indication information, the office efficiency indication information being associated with usage of an office management function in the preset instant messaging application by at least one of a current user and users associated with the current user; and a reminding unit configured to, when the office efficiency indication information corresponds to a predefined low office efficiency, initiate a reservation reminder for the preset service to at least one of the current user and the users associated with the current user by the preset instant messaging application, wherein the preset service is associated with improvement of office efficiency.

What is claimed is:

1. A method comprising:
receiving a reservation request for a preset service initiated via a preset instant messaging application;
determining a service mode designated by the reservation request; and
responding to the reservation request according to the service mode to enable an initiator of the reservation request to obtain the preset service.

2. The method of claim 1, wherein the service mode comprises at least one of the following:
an online service type;
an offline remote communication service type; and
an offline face-to-face teaching service type.

3. The method of claim 1, wherein the responding to the reservation request according to the service mode comprises:
selecting at least one service provider from preset service providers corresponding to the service mode; and
sending a service instruction associated with the reservation request to a respective service provider, so that the initiator of the reservation request obtains the preset service after the respective service provider executes the service instruction.

4. The method of claim 3, wherein the selecting at least one service provider from the preset service providers corresponding to the service mode comprises:
determining that the reservation request comprises a preset feature attribute of the initiator of the reservation request; and
selecting, according to the preset feature attribute, the at least one service provider from the preset service providers corresponding to the service mode.

5. The method of claim 4, wherein the preset feature attribute comprises at least one of the following:
an age;
a location; and
a group scale.

6. The method of claim 3, wherein the selecting at least one service provider from the preset service providers corresponding to the service mode comprises:
determining that the reservation request comprises a service requirement input by the initiator; and
selecting, according to the service requirement, the at least one service provider from the preset service providers corresponding to the service mode

7. The method of claim 1, wherein the responding to the reservation request according to the service mode comprises:
sending a reservation notification associated with the reservation request to a service provider of preset service providers corresponding to the service mode;
determining that a response message for the reservation notification from the service provider is received; and
sending a service instruction associated with the reservation request to the service provider, so that the initiator of the reservation request obtains the preset service after the service provider executes the service instruction.

8. The method of claim 7, wherein the responding to the reservation request according to the service mode further comprises:
determining that response messages for the reservation notification from multiple service providers are received; and
sending, according to a response order of the multiple service providers, the service instruction associated with the reservation request to a preset number of service providers.

9. The method of claim 7, wherein the responding to the reservation request according to the service mode further comprises:
acquiring a response condition of the reservation notification; and
sending the response condition to the initiator of the reservation request.

10. The method of claim 1, wherein the responding to the reservation request according to the service mode comprises:
determining that the service mode is a meeting of an offline face-to-face teaching service type;
determining that there is a remaining reservation spot for the meeting; and
adding the initiator of the reservation request as a member that has made a reservation for the meeting.

11. The method of claim 1, wherein the initiator of the reservation request meets at least one of the following predefined reservation permission conditions:
a location of the initiator belongs to a preset region;
a creation date of a team to which the initiator belongs is within a preset time length;
a number of members of a team to which the initiator belongs is not less than a preset number; and
an administrative permission level of the initiator in the team reaches a preset level.

12. The method of claim 1, further comprising:
receiving a configuration request for the preset service from the initiator of the reservation request; and
configuring the preset service according to the configuration request to update or cancel the preset service.

13. The method of claim 1, further comprising:
receiving completion status information uploaded by a service provider about the preset service associated with the reservation request; and
allocating a corresponding preset transaction object to the service provider according to the completion status information.

14. The method of claim 1, further comprising:
receiving evaluation information for the obtained preset service from the initiator of the reservation request; and
rewarding or punishing, according to the evaluation information, the service provider providing the preset service.

15. The method of claim 1, wherein the preset service comprises a teaching service for a preset application function of the preset instant messaging application.

16. The method of claim 1, wherein the preset instant messaging application is an enterprise instant messaging application.

17. The method of claim 1, further comprising:
acquiring office efficiency indication information, the office efficiency indication information being associated with usage of an office management function in the preset instant messaging application by at least one of a current user and a user associated with the current user, the office efficiency indicating information corresponds to a predefined low office efficiency; and
initiating a reservation reminder for the preset service to at least one of the current user and the users associated with the current user by the preset instant messaging application, the preset service being associated with improvement of office efficiency.

18. An apparatus comprising:
one or more processors; and
computer readable media storing thereon computer-readable instructions that, when executed by the one or more processors, cause the one or more processors to perform acts comprising:
receiving a reservation request for a preset service initiated by a preset instant messaging application;
determining a service mode designated by the reservation request; and
responding to the reservation request according to the service mode to enable an initiator of the reservation request to obtain the preset service.

19. The apparatus of claim 18, wherein the service mode comprises at least one of the following:
an online service type;
an offline remote communication service type; and
an offline face-to-face teaching service type.

20. Computable readable media storing thereon computer-readable instructions that, when executed by one or more processors, cause the one or more processors to perform acts comprising:
receiving a reservation request for a preset service initiated by a preset instant messaging application;
determining a service mode designated by the reservation request; and
responding to the reservation request according to the service mode to enable an initiator of the reservation request to obtain the preset service.
